(19) United States
(12) Patent Application Publication
(10) Pub. No.: US 2023/0190423 A1
(43) Pub. Date: Jun. 22, 2023

(54) DATA LOCKING SYSTEM AND DATA LOCKING METHOD

(71) Applicant: MEDIT CORP., Seoul (KR)

(72) Inventors: Dong Hoon LEE, Seoul (KR); Dong Hwa KANG, Seoul (KR)

(73) Assignee: MEDIT CORP., Seoul (KR)

(21) Appl. No.: 18/015,182

(22) PCT Filed: Jul. 12, 2021
(86) PCT No.: PCT/KR2021/008861

§ 371 Date: Jan. 9, 2023

(30) Foreign Application Priority Data
Jul. 10, 2020 (KR) 10-2020-0085434

(51) Int. Cl. A61C 9/00; G06T 19/20; G06T 17/00; G06T 7/90

(52) U.S. Cl. CPC A61C 9/0053; G06T 19/20; G06T 17/00; G06T 7/90; G06T 2200/24; G06T 2219/2004; G06T 2219/2012; G06T 2210/41; G06T 2207/30036

(57) ABSTRACT

According to a data locking system and a data locking method, data obtained from a scanner is converted into a real-time three-dimensional surface having unit cells. The unit cells constituting the real-time three-dimensional surface include at least one piece of characteristic information having a variety of information such as color, curvature, reliability color, or data density. When new data is input from the scanner, after performing a real-time three-dimensional surface conversion and aligning process, the characteristic information assigned to the unit cells may be updated or update-restricted according to the characteristic information about a corresponding point. On the other hand, when a specific critical condition (a specific condition of the characteristic information) is assigned, there is an advantage of preventing unnecessary resources from being used in the process of forming an intraoral model by not updating the characteristic information even when new data is input for a corresponding unit cell.

### TECHNICAL FIELD

The present disclosure relates to a data locking system and a data locking method.

### BACKGROUND ART

As one method of obtaining intraoral information of a patient, a three-dimensional intraoral scanner that is inserted into a patient's oral cavity to generate a three-dimensional virtual model is frequently used. In addition, a three-dimensional table scanner that generates a three-dimensional virtual model of a plaster model obtained by taking an alginate impression of a patient's teeth is constantly used. A three-dimensional virtual model obtained through a three-dimensional scanner (including an intraoral scanner and a table scanner) includes a patient's maxillary scan data, mandibular scan data, and occlusion scan data. For a tooth requiring treatment, a dental restoration, such as a crown, may be manufactured through modeling using a computer aided design (CAD) program.

In general, the three-dimensional scanner may obtain a two-dimensional image of an object through a light projector for emitting specific light to an object to be scanned (the inside of a patient's oral cavity including teeth and gingiva) or a plaster model within the scanner and a camera unit for receiving light emitted from the light projector and reflected from the surface of the object, and may finally generate and display a three-dimensional intraoral model. However, when data obtained through the light received in the process of generating the three-dimensional intraoral model is accumulated indefinitely, many unnecessary system resources may be used in the process of finally aligning and merging data. The inefficient use of system resources may hinder rapid completion of a three-dimensional intraoral model. On the other hand, there is a problem in that the reliability of the three-dimensional intraoral model is not guaranteed when erroneous data such as soft tissue is obtained.

### DISCLOSURE

### Technical Problem

The present disclosure aims to provide a data locking system for performing data locking (update restriction) on data obtained through a scanner on a unit cell basis according to a degree of reliability of the obtained data.

In addition, the present disclosure aims to provide a data locking method of performing data locking (update restriction) so that additional data accumulation is not performed through the determination of a controller with respect to a point where sufficient reliable data is accumulated through a series of processes.

The technical objectives of the present disclosure are not limited to those described above, and other technical objectives that are not described herein will be clearly understood by those of ordinary skill in the art from the following descriptions.

### Technical Solution

To achieve the objectives described above, a data locking system may include: a scanner configured to emit light toward an object to be scanned and receive light reflected from the object; and a controller configured to process a plurality of pieces of data obtained from the light received by the scanner so as to be displayed on a user interface in a form of a real-time three-dimensional surface, and to determine whether to store the data, based on a characteristic of the real-time three-dimensional surface.

In addition, the controller may include: a three-dimensional data generator configured to convert the data obtained from the scanner into the real-time three-dimensional surface including at least one unit cell; an aligner configured to align a location of the real-time three-dimensional surface; a characteristic assigner configured to assign characteristic information to the unit cell; a corresponding point determiner configured to determine whether the characteristic information is less than a critical value for the unit cell of the aligned real-time three-dimensional surface; and a merger configured to generate a three-dimensional intraoral model by merging the aligned real-time three-dimensional surface.

In addition, the unit cell may be a voxel having a volume, and the unit cell may include at least one piece of the characteristic information including data density, curvature, object color, and reliability color.

In addition, the characteristic assigner may be further configured to assign information about the reliability color to the unit cell, and the information about the reliability color is assigned to correspond to a magnitude of the data density.

In addition, the information about the reliability color may include at least two colors corresponding to the magnitude of the data density.

In addition, the corresponding point determiner may be further configured to identify the characteristic information of the unit cell corresponding to an overlapped and aligned portion of the real-time three-dimensional surface.

In addition, the corresponding point determiner may be further configured to selectively update the characteristic information included in the unit cell through the characteristic assigner according to the characteristic information of the unit cell.

In addition, the characteristic information identified by the corresponding point determiner may be information about the reliability color.

In addition, when the information about the reliability color assigned to the unit cell corresponds to a critical color, the data obtained from the scanner may not be stored in the corresponding unit cell.

In addition, the critical color may be green.

In addition, when the information about the reliability color assigned to the unit cell corresponds to a critical color, the characteristic assigner may be further configured to assign update restriction information to the unit cell.

In addition, when the update restriction information is assigned to the unit cell, the corresponding point determiner may be further configured not to store the data obtained from the scanner in the corresponding unit cell.

In addition, the data locking system may further include a display displaying at least a portion of the characteristic information on the user interface.

On the other hand, a data locking method according to the present disclosure may include: a scanning operation of receiving light reflected from an object to be scanned; a real-time three-dimensional surface generating operation of converting image data obtained by the light received in the scanning operation into a form of a real-time three-dimensional surface including at least one unit cell; an aligning operation of aligning an overlapped unit cell of the real-time three-dimensional surface; and a corresponding point determining operation of determining whether to selectively update characteristic information included in the unit cell according to the characteristic information of the unit cell.

In addition, the unit cell may be a voxel having a volume, and the unit cell may include at least one piece of the characteristic information including data density, curvature, object color, and reliability color.

In addition, the data locking method may further include a real-time three-dimensional surface updating operation of, when the unit cell to be updated is determined according to the corresponding point determining operation, updating the characteristic information included in the corresponding unit cell.

In addition, when the characteristic information included in the unit cell corresponds to a critical condition, data obtained from the scanning operation may not be stored in the corresponding unit cell.

In addition, the critical condition may be information about the reliability color, and the information about the reliability color may be assigned to correspond to a magnitude of the data density.

In addition, when the about the reliability color corresponding to the critical condition corresponds to a critical color, the data obtained from the scanning operation may not be stored in the corresponding unit cell.

In addition, the critical color may be green.

In addition, the data locking method may further include a merging operation of generating an intraoral model by merging the real-time three-dimensional surface.

### Advantageous Effects

By using a data locking system and a data locking method according to the present disclosure, a unit cell that has reached a critical condition may restrict data update or accumulation even when additional data is input through a scanner, thereby preventing use of unnecessary resources. This provides an advantage of being able to obtain a highly reliable intraoral model.

In addition, when the data locking system and the data locking method according to the present disclosure are used, characteristic information may be selectively updated in the unit cell. This provides an advantage of easily filtering noise data and minimizing user inconvenience.

In addition, whether data density reaches a critical value may be determined on a unit cell basis and data locking may be performed. This may provide an advantage of being able to precisely scan an entire object to be scanned.

### DESCRIPTION OF DRAWINGS

FIG. 1 is a schematic configuration diagram of a data locking system according to the present disclosure.

FIG. 2 is a reference diagram for explaining degrees of accumulation of data in a plurality of scan ranges, in order to describe the data locking system according to the present disclosure.

FIGS. 3 to 7 are reference diagrams in which a real-time three-dimensional surface is generated and displayed according to scanning performed by a scanner on a user interface displayed on a display, in order to describe the data locking system according to the present disclosure.

FIGS. 8 to 10 are diagrams for explaining a process of updating characteristic information when data is input to a corresponding unit cell, in order to describe the data locking system according to the present disclosure.

FIG. 11 is a flowchart of a data locking method according to the present disclosure.

### BEST MODE

Hereinafter, some embodiments of the present disclosure will be described in detail with reference to example drawings. In assigning reference numerals to elements of the drawings, it should be noted that the same elements are denoted by the same reference numerals as much as possible even though the same elements are illustrated in different drawings. In addition, in describing the embodiments of the present disclosure, when the detailed descriptions of the relevant known functions or configurations are determined to unnecessarily obscure the gist of the present disclosure, detailed descriptions thereof are omitted.

Terms, such as “first,” “second,” “A,” “B,” “(a),” or “(b)” may be used herein to describe the elements of the present disclosure. These terms are only for distinguishing one element from another, and the essence, order, or sequence of the elements is not limited by the terms. In addition, unless defined otherwise, all terms including technical or scientific terms as used herein have the same meaning as commonly understood by those of ordinary skill in the art. It will be understood that terms, such as those defined in commonly used dictionaries, should be interpreted as having a meaning that is consistent with their meaning in the context of the relevant art and will not be interpreted in an idealized or overly formal sense unless expressly so defined herein.

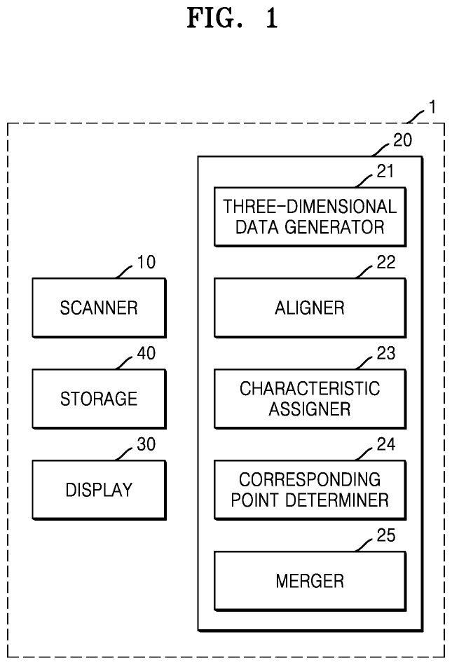

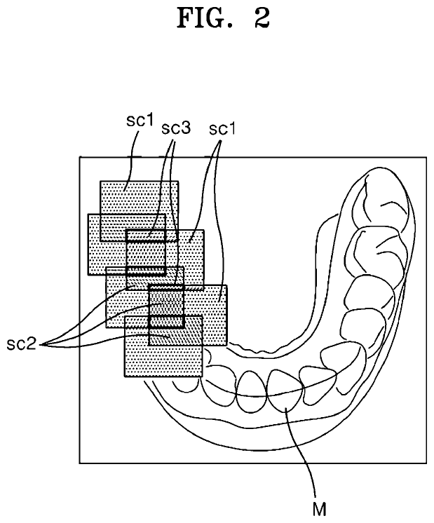

FIG. 1 is a schematic configuration diagram of a data locking system according to the present disclosure, and FIG. 2 is a reference diagram for explaining degrees of accumulation of data in a plurality of scan ranges, in order to describe the data locking system according to the present disclosure.

Referring to FIG. 1, the data locking system according to the present disclosure may include a scanner 10 that emits light toward an object M to be scanned and receives light reflected from the object M, and a controller 20 that processes a plurality of pieces of data obtained from the light received by the scanner 10 so as to be displayed on a user interface in a form of a real-time three-dimensional surface M′, and determines whether to store data, based on the characteristic of the real-time three-dimensional surface M′.

First, as briefly described in the background art, the scanner 10 may be an intraoral scanner that is gripped by a practitioner's hand to scan a patient's oral cavity or a plaster model obtained through impression taking, or may be a table scanner that scans a plaster model placed on a tray. The scanner 10 includes at least one camera and analyzes light received through this camera to generate a two-dimensional image. The two-dimensional image may be generated by an imaging sensor that is electrically and communicatively connected to the camera. For example, a complementary metal-oxide semiconductor (CMOS) sensor may correspond to the imaging sensor.

On the other hand, the scanner 10 may include a light projector in order to obtain stereoscopic information for converting a two-dimensional image into a real-time three-dimensional surface. The light projector emits light toward an object and allows light reflected from the object to be received by a camera formed in the scanner 10. The light emitted from the light projector toward the object may be structured light having a certain pattern. The pattern of the structured light may be fixed or may be variable so that a certain rule is circulated.

Referring to FIG. 2, scanning that is performed from one end to the other end of an object is illustrated. When two-dimensional image data is obtained from the scanner 10, a three-dimensional data generator 21 of the controller 20 may convert this data into a real-time three-dimensional surface including at least one unit cell. The real-time three-dimensional surface may be three-dimensionally represented on the user interface, and unit cells constituting the real-time three-dimensional surface may represent the surface of the object. More specifically, the unit cells constituting the real-time three-dimensional surface may be voxels having a volume like a three-dimensional pixel, and the unit cell may include at least one of various pieces of characteristic information. At this time, the characteristic information may include data density, curvature, object color, reliability color, update restriction information, and the like.

The scanning process of the scanner 10 has been described above as performing scanning from one end to the other end of the object, but the scanning process does not necessarily have to be performed from one end to the other end, and the scanning process may also be performed from the center toward both sides. In the case of the table scanner, a real-time three-dimensional surface may be generated while rotating or tilting the object M within a range where a scan overlap area is formed.

On the other hand, when the object M is scanned in FIG. 2, more data may be accumulated when the scanned areas overlap each other. For example, in a case where scanning is performed on six areas as illustrated, when data of the object M is obtained by one scan area, it corresponds to a first scan area sc1, and when data of the object M is obtained by two scan areas, it corresponds to a second scan area sc2. In addition, when data is obtained by three scan areas, it may correspond to a third scan area sc3. A degree of accumulation of data (in the present specification, this is referred to as data density) increases in the order of the first scan area sc1, the second scan area sc2, and the third scan area sc3.

More specifically, the data density among the pieces of characteristic information described above refers to a degree of accumulation of data corresponding to a corresponding unit cell. As the data density increases, more corresponding data according to the scanning process is accumulated, thus increasing reliability. For other characteristic information, the curvature and the object color correspond to surface information of the object, and have pieces of information that may realistically represent the real-time three-dimensional surface on the user interface. The reliability color is an index representing the accuracy (or reliability) of data included in the unit cell, and information about the reliability color may be assigned to correspond to the magnitude of the data density. At this time, the information about the reliability color may be assigned in at least two different colors so as to correspond to the magnitude of the data density. In this case, assigning the characteristic information is performed by a characteristic assigner 23 included in the controller 20. The characteristic assigner 23 may assign the characteristic information after a corresponding point determiner 24 identifies the characteristic information of the unit cell. The determination of the characteristic information by the corresponding point determiner 24 will be described below.

For example, when the data density is 0, there is no reliability color that is assigned to the corresponding unit cell and displayed on the user interface. When the data density is 0, the reliability is also 0 because no data is input to the corresponding location. When the data density is greater than 0 and less than a first reference point, the reliability color that is assigned to the corresponding unit cell and displayed on the user interface may be a first reliability color or a first pattern. In addition, when the data density is greater than the first reference point and less than a second reference point, the reliability color that is assigned to the corresponding unit cell and displayed on the user interface may be a second reliability color or a second pattern. In addition, when the data density is greater than the second reference point, the reliability color that is assigned to the corresponding unit cell and displayed on the user interface may be a third reliability color or a third pattern.

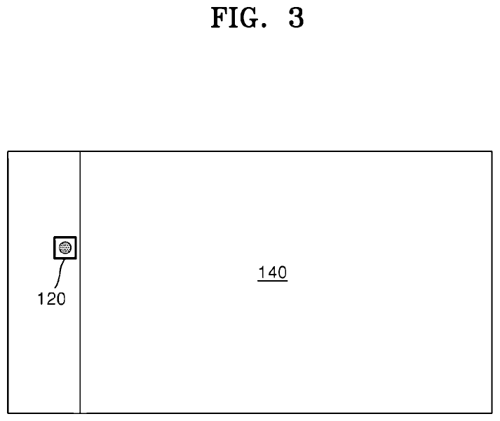

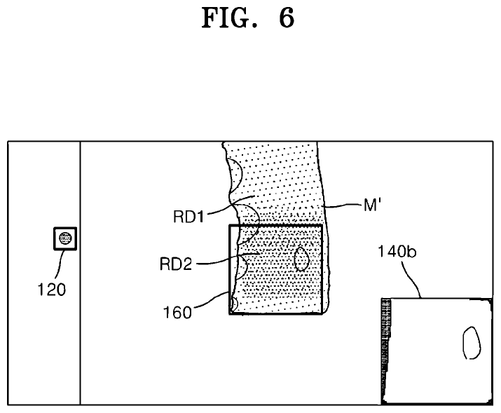

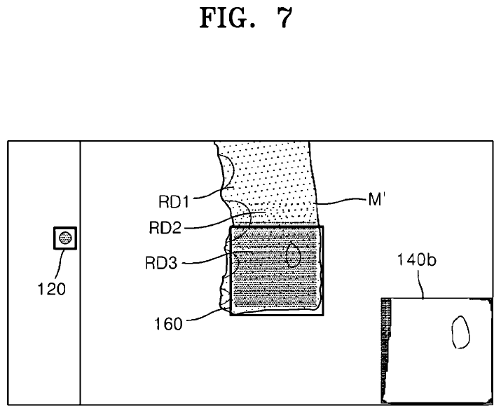

FIGS. 3 to 7 are reference diagrams in which a real-time three-dimensional surface is generated and displayed according to scanning performed by the scanner on the user interface displayed on the display, in order to describe the data locking system according to the present disclosure.

Referring to FIG. 3, a screen before the scanning process by the scanner 10 is initially performed is illustrated. A reliability display button 120 may be formed on one side of the screen, and a user interface 140 is formed on the other side of the screen. When the reliability display button 120 is clicked, various states of the real-time three-dimensional surface M′ displayed on the user interface may be switched and displayed. The real-time three-dimensional surface M′ may or may not display the reliability color according to the clicking of the reliability display button 120. Alternatively, at least one of various pieces of characteristic information of the unit cells constituting the real-time three-dimensional surface M′ may be displayed according to the clicking of the reliability display button 120. As illustrated in FIG. 3, because it is before the scanning process is performed, there are no generated real-time three-dimensional surfaces and unit cells, and characteristic information that may be displayed is also in a non-assigned state.

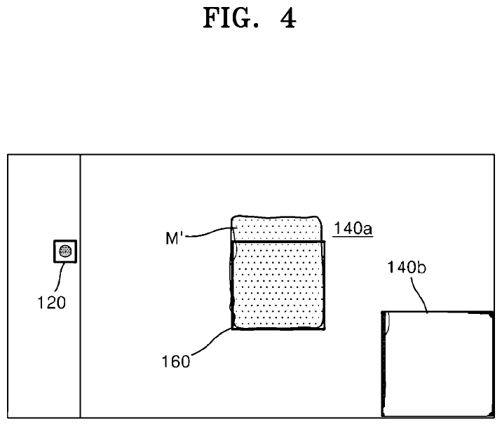

Referring to FIG. 4, two-dimensional image data input from the scanner 10 is converted into the real-time three-dimensional surface M′ by the three-dimensional data generator 21 and is displayed on the user interface 140. In this case, one or more real-time three-dimensional surfaces M′ that are generated by the three-dimensional data generator 21 are aligned to correspond to overlap points. The alignment between the real-time three-dimensional surfaces may be performed by using the most suitable method among various alignment methods. Preferably, the alignment may be performed by using an iterative closest point (ICP) method. The area currently being scanned is displayed as the real-time three-dimensional surface in a scan area 160 corresponding to a portion of a model display area 140a, and two-dimensional image data input through the scanner 10 is displayed on a real-time display area 140b.

When alignment is performed by an aligner 22, characteristic information is assigned to the unit cell of the aligned real-time three-dimensional surface M′. At this time, the characteristic information assigned to the unit cell may include data density, reliability color, update restriction information, and the like, as described above. For example, the update restriction information may be information restricting the input of additional data to a corresponding unit cell when data density corresponding to a certain critical value is accumulated. That is, the update restriction information may be information dependent on the data density. When data density of an arbitrary unit cell corresponds to a certain critical value, the update restriction information may be ON (update restriction). However, the present disclosure is not necessarily limited thereto, and the update restriction information may be represented by using two contrasting marks. For example, the update restriction information may be represented by 0 (update permission) and 1 (update restriction), or may be represented by OFF (update permission) and ON (update restriction).

When the same data is input, the data density increases, and information about the reliability color may be assigned together to correspond to the magnitude of the data density.

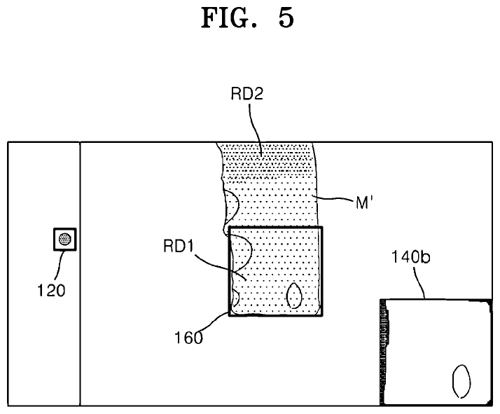

Referring to FIGS. 5 to 7, a first reliability color RD1, a second reliability color RD2, or a third reliability color RD3 may be displayed according to a degree of accumulation of data. For example, the first reliability color may be red, the second reliability color may be yellow, and the third reliability color may be green. Upon scanning an object M, a practitioner may easily visually identify a part where reliable data is obtained and a part where reliable data is not obtained, through the reliability color of the real-time three-dimensional surface M′ displayed on the user interface 140. An intraoral model with high reliability as a whole may be obtained by performing additional scanning on parts indicated by the first reliability color RD1 and the second reliability color RD2.

On the other hand, the data locking system 1 according to the present disclosure may further include a corresponding point determiner 24 that aligns the location of the real-time three-dimensional surface M′ and determines whether characteristic information is less than a critical value with respect to the unit cell of the real-time three-dimensional surface M′, so as to obtain an intraoral model with high reliability through accumulation of data that is input according to the scanning process.

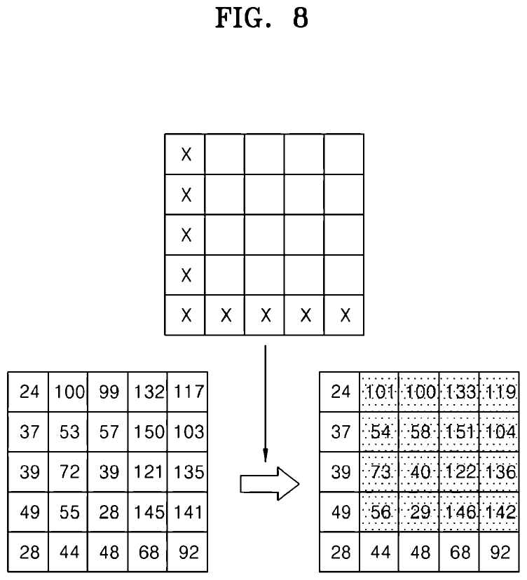

FIGS. 8 to 10 are diagrams for explaining a process of updating characteristic information when data is input to the corresponding unit cell, in order to describe the data locking system 1 according to the present disclosure. At this time, the characteristic information is exemplarily described in detail by using the data density (or reliability color), and the critical value of the data density is set to 500.

Referring to FIG. 8, a plurality of unit cells formed in an arbitrary scan area are exemplarily illustrated in a form of a 5×5 matrix in order to explain the present disclosure. Characteristic information of data (real-time three-dimensional surface converted from two-dimensional image data and including at least one unit cell) input according to the scanning of the scanner 10 may be assigned and updated to each unit cell. As illustrated in FIG. 8, the data density is accumulated in each unit cell, it is assumed that the data input according to the scanning of the scanner 10 is a part corresponding to a 4×4 matrix of an upper right corner, and unit cells indicated by ‘X’ mean that data corresponding to the existing scan area is not input. In this case, the corresponding point determiner identifies the characteristic information of the unit cell corresponding to the 4×4 matrix of the overlapped and aligned upper right corner of the real-time three-dimensional surface M′. In FIG. 8, because there is no unit cell that has reached the critical value of data density in the unit cells of the part where newly input real-time three-dimensional surface overlaps, the characteristic assigner 23 updates characteristic information included in the corresponding unit cell. Characteristic information of shaded unit cells in FIG. 8 is updated so that the data density increased according to newly input data.

The process of updating the characteristic information will be described in more detail. For example, a plurality of unit cells formed in an arbitrary scan area are illustrated in a form of a 5×5 matrix. When data is input to a part corresponding to a 4×4 matrix of an upper right corner, the characteristic assigner 23 may compare characteristic information of each unit cell with characteristic information of data input to a corresponding location. The characteristic assigner 23 may selectively update the characteristic information by comparing the characteristic information of the existing unit cell with the characteristic information of newly input data. For example, when object curvature and/or object color information of the newly input data is the same as object curvature and/or object color information of an arbitrary unit cell, the characteristic assigner 23 may add the data density of the corresponding unit cell by a certain value (e.g., 1). In addition, when object curvature and/or object color information of the newly input data is different from object curvature and/or object color information of an arbitrary unit cell, the characteristic assigner 23 may not update characteristic information in the corresponding unit cell and may not add the data density.

For example, the process by which the characteristic assigner 23 selectively updates the characteristic information in the unit cell may be performed when each unit cell has a data density greater than a certain sub-critical value. That is, when scanning is performed by the scanner 10 and the critical value for update restriction of the unit cell is 500, the sub-critical value may be set to 100. That is, when the data density is less than 100, data newly obtained by scanning and characteristic information included in the data may all be stored in the corresponding unit cell. On the other hand, when the data density is 100 or more, data newly obtained by scanning may be selectively updated based on dominant characteristic information of the corresponding unit cell. For example, in a case where the characteristic information of an arbitrary unit cell is greater than or equal to the sub-critical value and less than or equal to the (main) critical value, the characteristic assigner 23 may add the certain value of the data density only when the characteristic information of the newly obtained data is the same as the dominant characteristic information of the existing unit cell.

The ‘dominant characteristic information’ will be described in more detail. To describe this, the color of the object will be taken as an example. When the arbitrary unit cell has a data density less than the sub-critical value and the obtained characteristic information is an object color of 50 reds, 30 pinks, and 19 yellows, the dominant characteristic information of the corresponding unit cell may be red. Thereafter, when the scanning process is performed, in a case where the characteristic information of the newly obtained data is not red, the newly obtained data may be determined as noise, the characteristic information may not be updated in the corresponding unit cell, and the data density may not be added.

As described above, when the ‘dominant characteristic information’ is determined from the characteristic information obtained when the data density is less than the sub-critical value, it is possible to effectively prevent noise data from being accumulated in the unit cell. Therefore, the data locking system according to the present disclosure may have highly reliable characteristic information for all intraoral models, and may have an advantage of being able to minimize user inconvenience, such as arbitrarily deleting an erroneously obtained part and re-scanning.

However, the above description is only illustrative, and the numerical value of the sub-critical value used to explain the present disclosure, the elements for determining the identity of the characteristic information, and the like may be differently applied in order to obtain a highly reliable intraoral model by a user's selection and/or automatically.

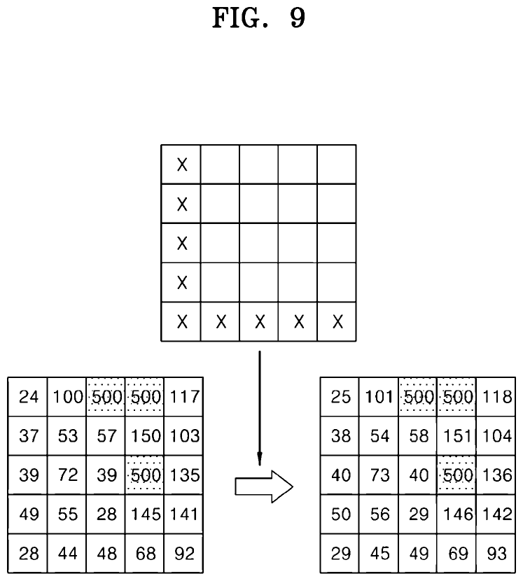

Referring to FIG. 9, the data density of some unit cells may have reached a critical value. Shaded unit cells among the unit cells of the left 5×5 matrix correspond to unit cells, the data density of which reaches the critical value. Because a sufficient amount of data for obtaining a highly reliable intraoral model is accumulated in the unit cell, the obtaining of additional data may cause waste of system resources and distortion of data. Accordingly, the characteristic information of the unit cell, the characteristic information of which is less than the critical value, among the unit cells corresponding to new data input from the scanner 10 is updated, and data is not stored in the unit cell, the characteristic information of which is equal to or greater than the critical value. That is, the data density of the unit cell corresponding to the data density of 500 among the parts corresponding to the unit cells to which the new data is input does not increase even when the new data is input, and the characteristic information of other unit cells is updated to increase the data density. That is, the unit cells, the data density of which has reached the critical value may be locked so that no more data is added. As described above, because the existing data is updated with the data obtained from the scanner 10, there is an advantage in that an intraoral model with high reliability as a whole may be obtained and precise treatment may be provided to a patient.

At this time, in the data locking system according to the present disclosure, the expression “the data density does not reach the critical value” does not mean that data is incorrectly input to the corresponding unit cell. That is, the process of locking the unit cells, the data density of which has reached the critical value, updating the characteristic information for the remaining unit cells, and increasing the data density is performed for obtaining an intraoral model with high reliability as a whole, and the unit cell, the data density of which does not reach the critical value, is not determined as abnormal data. In addition, the characteristic information of the unit cell, the data density of which does not reach the critical value, is not ‘replaced’ by the newly input data, and a sufficient amount of data may be additionally accumulated in the corresponding unit cell so that the data density reaches the critical value.

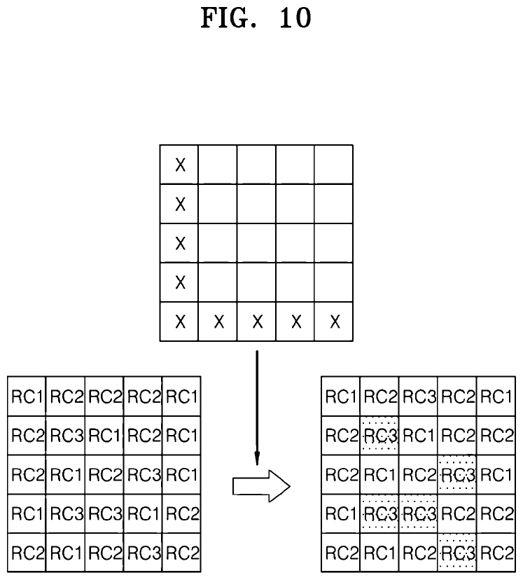

On the other hand, referring to FIG. 10, the characteristic information identified by the corresponding point determiner 24 may be information about reliability color rather than data density. Three reliability colors RD1, RD2, and RD3 are assigned according to the magnitude of the data density. For example, when the magnitude of the data density is in a first range (greater than or equal to 1 and less than the sub-critical value), the first reliability color RD1 may be assigned to the corresponding unit cell. In addition, when the magnitude of the data density is in a second range (greater than or equal to the sub-critical value and less than the (main) critical value), the second reliability color RD2 may be assigned to the corresponding unit cell. In addition, when the magnitude of the data density is equal to the critical value, the third reliability color RD3 may be assigned to the corresponding unit cell. At this time, the third reliability color RD3 is a critical color assigned to a unit cell in which a sufficient amount of data density is accumulated and additional data input is unnecessary. Regarding the unit cell to which the critical color is assigned, even when new data is input from the scanner 10, new data is not stored in the corresponding unit cell. The critical color may be green, and new data may not be stored in the unit cell, the reliability color of which is green. As illustrated in FIG. 10, because the shaded unit cell has already been assigned the third reliability color RD3, which is the critical color, additional data is not stored even when new data is input, and thus, characteristic information is not updated. Accordingly, additional data is not accumulated in the unit cell, the reliability color of which is green, and newly input additional data is accumulated in the unit cells, the reliability color of which is not green (there is no reliability color, or the reliability color is the first reliability color that is red or the second reliability color that is yellow). Therefore, there is an advantage of being able to obtain an intraoral model with high reliability as a whole. The reliability color has been described as having three colors (red, yellow, and green) in stages, but the present disclosure is not necessarily limited thereto. Any configuration in which n reliability colors may be assigned according to the magnitude of the data density is possible, and the data density may also be changed according to the user's selection.

On the other hand, as described above, the unit cell having the first reliability color RD1 or the second reliability color RD2 is not determined as abnormal data. In addition, the first reliability color RD1, the second reliability color RD2, and the third reliability color RD3 do not represent different abnormal states. In addition, the characteristic information of the unit cell, the data density of which does not reach the critical value, is not ‘replaced’ by the newly input data, and a sufficient amount of data may be additionally accumulated in the corresponding unit cell so that the data density reaches the critical value. Accordingly, the reliability color of the corresponding unit cell may also be changed to the third reliability color RD3.

On the other hand, when the critical color is assigned as the reliability color to the unit cells constituting the real-time three-dimensional surface, the characteristic assigner 23 may additionally assign update restriction information to the corresponding unit cell. For example, for the unit cell to which the critical color is not assigned among the unit cells constituting the real-time three-dimensional surface, an initial value is set for the update restriction information. In this case, the initial value may be 0. In contrast, in the unit cell to which the critical color (green) is assigned among the unit cells constituting the real-time three-dimensional surface, a value different from the initial value is set for the update restriction information, and the value at this time may be 1. Accordingly, the corresponding point determiner 24 may not store the data obtained from the scanner 10 in the corresponding unit cell when the update restriction information is assigned to the unit cell (set to a value other than the initial value). As described above, when determining whether to additionally accumulate data through update restriction information, there is an advantage of simplifying the determination process. However, in addition to the numerical update restriction information classification method as described above, various methods may be applied to indicate that additional data accumulation is no longer required due to sufficient data accumulation in the corresponding unit cell.

Operations of the controller 20, such as the operations of generating and aligning the real-time three-dimensional surface and displaying the characteristic information (particularly, reliability color) as described above, may be displayed on the display 30 on which the user interface is displayed. The practitioner may easily confirm whether the scanning is smoothly performed through the display 30. Any configuration capable of displaying the user interface may be applied to the display 30, and the display 30 may be a screen device including a liquid crystal display (LCD) panel and a light-emitting diode (LED) panel.

The data obtained by the scanning of the scanner 10, the characteristic information of the unit cells of the real-time three-dimensional surface, and the like may be stored in a storage 40. When the scanning-related processes (real-time three-dimensional surface generation, alignment, characteristic information assignment, corresponding point determination, and characteristic information update) are completed, data accumulated in the storage 40 may be merged with the real-time three-dimensional surface to generate a final three-dimensional intraoral model.

As described above, the data locking system according to the present disclosure performs data locking by determining whether the data density reaches the critical value (or whether the reliability color has the critical color) on a unit cell basis, thereby providing an advantage of being able to obtain a precise intraoral model with high reliability for the entire object. That is, the present disclosure has an advantage in that data may be accumulated with high reliability for each unit cell of the intraoral model representing the object, and the user may precisely scan the entire object.

The process of configuring the data locking system described above and the technical features of the data locking system according to the present disclosure are equally applied to a data locking method according to the present disclosure.

Hereinafter, a data locking method according to the present disclosure will be described in detail. However, the same description as provided above in the data locking system will be briefly mentioned or omitted.

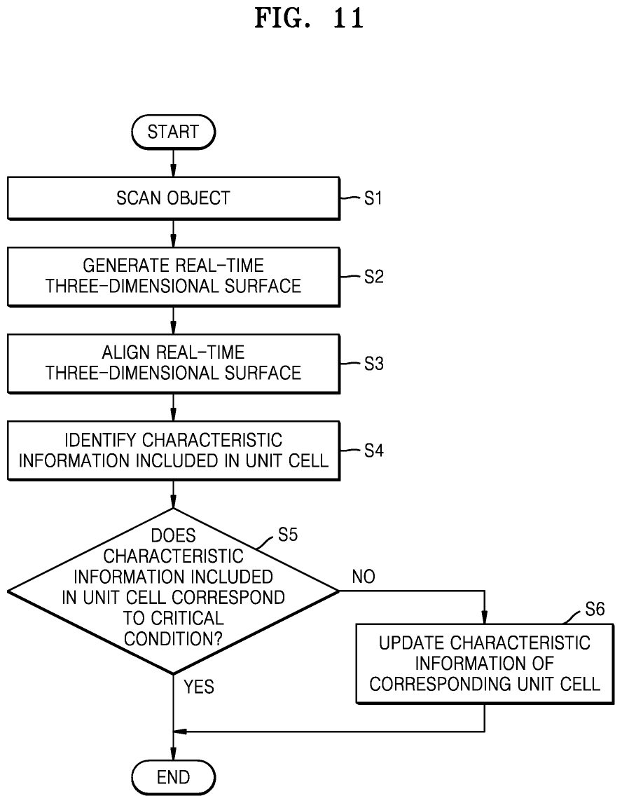

FIG. 11 is a flowchart of a data locking method according to the present disclosure.

Referring to FIG. 11, the data locking method according to the present disclosure may include a scanning operation S1 of receiving light reflected from an object to be scanned, a real-time three-dimensional surface generating operation S2 of converting image data obtained by the light received in the scanning operation S1 into a form of a real-time three-dimensional surface including at least one unit cell, and an aligning operation S3 of aligning overlapped unit cells of the real-time three-dimensional surface.

The scanning operation S1 is an operation by which a scanner obtains two-dimensional image data by receiving the light reflected from the object. In order to form two-dimensional image data into the real-time three-dimensional surface, structured light may be emitted to the object through a light projector included in the scanner. As described above, the light reflected from the object is received through a camera lens and is formed as two-dimensional image data by an imaging sensor that is electrically and communicatively connected to the camera.

The real-time three-dimensional surface generating operation S2 is an operation of converting the generated two-dimensional image data into the real-time three-dimensional surface having surface information. The real-time three-dimensional surface may include at least one unit cell in a form of a voxel having a volume, and characteristic information of the location corresponding to the real-time three-dimensional surface may be assigned to the unit cell. In this case, as described above, the characteristic information may be at least one of curvature, object color, data density, reliability color, and update restriction information.

The aligning operation S3 is an operation of aligning overlapped unit cells of the real-time three-dimensional surface to match the corresponding locations. By aligning the unit cells at the corresponding locations, the three-dimensional intraoral model may be generated without distortion. As the method of aligning the unit cells of the real-time three-dimensional surface at the corresponding locations, an ICP method may be used.

On the other hand, the data locking method according to the present disclosure may further include a corresponding point determining operation S5 of determining whether to selectively update the characteristic information included in the unit cell according to the characteristic information of the unit cell. In the corresponding point determining operation, the characteristic information included in the unit cell is identified to determine whether the characteristic information included in the unit cell corresponds to a critical condition. In this case, the critical condition may be a critical value of specific characteristic information. For example, the critical condition may be a value representing a specific magnitude of data density, critical color among reliability colors, or update restriction information.

According to the corresponding point determining operation S5, the unit cell, the characteristic information of which does not correspond to the critical condition, may be determined as a target cell to be updated by new data input from a scanner. When the unit cell to be updated is determined, a real-time three-dimensional surface updating step S6 of updating the characteristic information included in the corresponding unit cell may be additionally performed. When the characteristic information included in the unit cell is the data density, the data density included in the unit cell to be updated may be added, or when the reliability color corresponding to the data density is assigned, the reliability color may be changed to correspond to a change in data density. The process of updating the characteristic information of the unit cell is the same as that in FIGS. 8 to 10 and described above.

On the other hand, when the characteristic information included in the unit cell corresponds to the critical condition, the data obtained from the scanning operation S1 may not be stored in the corresponding unit cell. When the characteristic information corresponds to the critical condition, accumulation of additional data in the corresponding unit cell may cause a deterioration in reliability of the intraoral model due to unnecessary use of system resources and data distortion. Accordingly, there is an advantage of improving reliability of the overall three-dimensional intraoral model because additional data is not accumulated in the unit cell having characteristic information corresponding to the critical condition.

The criterion for determining the critical condition may be information about the reliability color assigned to correspond to the data density. When it is determined that the reliability color corresponds to the critical color, the data obtained in the scanning operation S1 may not be stored in the corresponding unit cell. In this case, the critical color may be green.

When highly reliable data is formed through the operations described above, a merging operation of generating a three-dimensional intraoral model by merging the real-time three-dimensional surface may be performed.

On the other hand, in the data locking system and the data locking method according to the present disclosure, all operations are processed based on unit cells. By performing the data locking and the characteristic information update on a unit cell basis, the calculation process is simple and intuitive, compared to an existing configuration in which grouping is performed according to the scan area and data is locked, and thus, system resources may be efficiently used. As a result, there is an advantage of being able to quickly obtain a highly reliable three-dimensional intraoral model and provide accurate prosthetic treatment to the patient.

The above description is merely illustrative of the technical spirit of the present disclosure, and various modifications and changes can be made by those of ordinary skill in the art, without departing from the scope of the present disclosure.

Therefore, embodiments disclosed in the present disclosure are not intended to limit the technical spirit of the present disclosure, but are intended to explain the technical spirit of the present disclosure. The scope of the technical spirit of the present disclosure is not limited by these embodiments. The scope of the present disclosure should be interpreted by the appended claims, and all technical ideas within the scope equivalent thereto should be construed as falling within the scope of the present disclosure.

### INDUSTRIAL APPLICABILITY

The present disclosure provides a data locking system and a data locking method, in which data locking is performed on a unit cell basis to prevent unnecessary use of resources and obtain a highly reliable intraoral model.

1. A data locking system comprising:
a controller configured to process a plurality of pieces of data obtained from the light received by a scanner so as to be displayed on a user interface in a form of a real-time three-dimensional surface, and to determine whether to store the data, based on a characteristic of the real-time three-dimensional surface.

2. The data locking system of claim 1, wherein the controller comprises:
a three-dimensional data generator configured to convert the data obtained from the scanner into the real-time three-dimensional surface including at least one unit cell;
an aligner configured to align a location of the real-time three-dimensional surface;
a characteristic assigner configured to assign characteristic information to the unit cell;
a corresponding point determiner configured to determine whether the characteristic information is less than a critical value for the unit cell of the aligned real-time three-dimensional surface; and
a merger configured to generate a three-dimensional intraoral model by merging the aligned real-time three-dimensional surface.

3. The data locking system of claim 2, wherein the unit cell is a voxel having a volume, and the unit cell includes at least one piece of the characteristic information including data density, curvature, object color, and reliability color.

4. The data locking system of claim 3, wherein the characteristic assigner is further configured to assign information about the reliability color to the unit cell, and the information about the reliability color is assigned to correspond to a magnitude of the data density.

5. The data locking system of claim 4, wherein the information about the reliability color includes at least two colors corresponding to the magnitude of the data density.

6. The data locking system of claim 3, wherein the corresponding point determiner is further configured to identify the characteristic information of the unit cell corresponding to an overlapped and aligned portion of the real-time three-dimensional surface.

7. The data locking system of claim 6, wherein the corresponding point determiner is further configured to selectively update the characteristic information included in the unit cell through the characteristic assigner according to the characteristic information of the unit cell.

8. The data locking system of claim 6, wherein the characteristic information identified by the corresponding point determiner is information about the reliability color.

9. The data locking system of claim 8, wherein, when the information about the reliability color assigned to the unit cell corresponds to a critical color, the data obtained from the scanner is not stored in the corresponding unit cell.

10. The data locking system of claim 9, wherein the critical color is green.

11. The data locking system of claim 7, wherein, when the information about the reliability color assigned to the unit cell corresponds to a critical color, the characteristic assigner is further configured to assign update restriction information to the unit cell.

12. The data locking system of claim 11, wherein, when the update restriction information is assigned to the unit cell, the corresponding point determiner is further configured not to store the data obtained from the scanner in the corresponding unit cell.

13. The data locking system of claim 3, further comprising a display displaying at least a portion of the characteristic information on the user interface.

14. A data locking method comprising:
a scanning operation of receiving light reflected from an object to be scanned;
a real-time three-dimensional surface generating operation of converting image data obtained by the light received in the scanning operation into a form of a real-time three-dimensional surface including at least one unit cell;
an aligning operation of aligning an overlapped unit cell of the real-time three-dimensional surface; and
a corresponding point determining operation of determining whether to selectively update characteristic information included in the unit cell according to the characteristic information of the unit cell.

15. The data locking method of claim 14, wherein the unit cell is a voxel having a volume, and the unit cell includes at least one piece of the characteristic information including data density, curvature, object color, and reliability color.

16. The data locking method of claim 15, further comprising a real-time three-dimensional surface updating operation of, when the unit cell to be updated is determined according to the corresponding point determining operation, updating the characteristic information included in the corresponding unit cell.

17. The data locking method of claim 15, wherein, when the characteristic information included in the unit cell corresponds to a critical condition, data obtained from the scanning operation is not stored in the corresponding unit cell.

18. The data locking method of claim 17, wherein the critical condition is information about the reliability color, and the information about the reliability color is assigned to correspond to a magnitude of the data density.

19. The data locking method of claim 18, wherein, when the about the reliability color corresponding to the critical condition corresponds to a critical color, the data obtained from the scanning operation is not stored in the corresponding unit cell.

20. (canceled)

21. The data locking method of claim 16, further comprising a merging operation of generating an intraoral model by merging the real-time three-dimensional surface.
